(19) United States
(12) Patent Application Publication
(10) Pub. No.: US 2017/0236001 A1
(43) Pub. Date: Aug. 17, 2017

(54) DEVICE AND METHOD FOR TRANSFORMING A FACIAL IMAGE INTO A SET OF RECOGNIZABLE EMOTICONS

(71) Applicant: Daniel M. McLean, New York, NY (US)

(72) Inventor: Daniel M. McLean, New York, NY (US)

(21) Appl. No.: 15/041,910

(22) Filed: Feb. 11, 2016

(51) Int. Cl. G06K 9/00; G06F 3/0488; G06T 11/80; G09G 5/377

(52) U.S. Cl. CPC G06K 9/00281; G09G 5/377; G06F 3/04886; G06T 11/80; G09G 2354/00; G06T 2200/24; H04M 1/72552

(57) ABSTRACT

A set of recognizable custom emoticons representing a subject's face are created and can be used in electronic communications as conventional emoticons are used. A set of unique emoticons are derived from a single digital true image of a subject's face such that others familiar with the subject are likely to recognize each emoticon in the set as representing the subject. The subject's true facial image is modified to reflect the cartoonish style of emoticons. Optionally some facial features are replaced to create a set of emoticons each having distinct facial expressions, for example, sad, happy, surprised, frightened. Optionally other features, for example, glasses, hats, facial hair, can be added to enhance the emoticons. The resultant set of emoticons is then made available to be sent and received on all communication mediums where emoticons are currently used.

Applicant claims the benefit of U.S. Provisional Application No. 62/115,542 filed Feb. 12, 2015,

### BACKGROUND OF THE INVENTION

Electronic communication options have increased markedly in recent years. An increasingly common approach to convey mood or attitude in textual communication is the use of small graphic elements representing facial expressions either interspersed with text or standalone. A non-profit corporation called The Unicode Consortium has defined a set of these graphics, called “emoticons,” for use with the Unicode standard of communication. Most mobile operating systems (ANDROID, iOS, etc) implement this standard set of emoticons. The Unicode Consortium defines “emoticons” as follows:

“Emoticons (from ‘emotion’ plus ‘icon’) are specifically intended to depict facial expression or body posture as a way of conveying emotion or attitude in e-mail and text messages. They originated as ASCII character combinations such as :-) to indicate a smile—and by extension, a joke—and :-(to indicate a frown. In East Asia, a number of more elaborate sequences have been developed, such as (″)(-_-)(″) showing an upset face with hands raised. Over time, many systems began replacing such sequences with images, and also began providing ways to input emoticon images directly, such as a menu or palette.”

### SUMMARY OF THE INVENTION

The term “set” as used in this specification and claims means one or more elements but does not include the null set. The embodiments disclosed herein describe devices and methods for creating from a true digital image of a subject's face a set of emoticons which represent the subject's face, keeping them unique and recognizable as a representation of the subject's face, especially to others familiar with the subject. All the embodiments modify a target facial image to reflect the cartoonish style of emoticons, and provide a means by which a user can create multiple emoticons from the modified facial image, each emoticon having a correspondingly distinct facial expression, for example, sad, happy, surprised, frightened, angry, and others. Some embodiments allow a user to add other elements, that is, accessories such as glasses, hats, facial hair, and others. These custom emoticons can be sent and received on all communication mediums which accept emoticons.

These and other objects are accomplished by a method of transforming a subject's facial image into a recognizable emoticon comprises the steps: (a) obtaining a digital image of the subject's face and putting it into data memory of a processor; (b) removing any background of the digital image while preserving the facial image; (c) processing the facial image to make it cartoon-like but still recognizable as a representation of the face of the subject; and (d) making the processed facial image available for use as an emoticon in a communication medium. Another method of transforming a subject's facial image into a set of recognizable emoticons comprises the steps: (a) obtaining a digital image of the subject's face without expression and putting it into data memory of a processor; (b) removing any background of the digital image while preserving the facial image; (c) processing the facial image to make it cartoon-like but still recognizable as a representation of the face of the subject; (d) storing a copy of the processed facial image, (e) retrieving the stored copy and applying a customization process to it to create an emoticon; (f) adding the created emoticon to a set of emoticons, (g) if more emoticons are to be added to the set, repeating steps (e) through (f); (h) when the set of emoticons is complete making the set available for use in a communication medium. One method of removing any background comprises the steps: (a) displaying the digital image on a touch screen; (b) tapping or, tapping and dragging a user's finger on or across the background displayed on the touch screen; and (c) erasing an area around all locations the finger makes contact with the screen.

Another method of removing any background comprises the steps: (a) displaying the digital image on a touch screen; (b) tapping the background displayed on the touch screen with a user's finger; (c) selecting the pixel at the location tapped; (d) storing the color value of the selected pixel; (e) testing adjacent pixels and if their colors are within a threshold value of the stored pixel, erasing them; (f) for each pixel that is erased, testing all adjacent pixels against the threshold; (g) if any adjacent pixel falls with the threshold value erasing them; and (h) repeating steps (e) and (f) above until a boundary is encountered or there are no adjacent pixels within the threshold value.

One customization process comprises the steps: (a) selecting a facial feature of the processed image for customization, (b) erasing the selected feature, and (c) superimposing a pre-existing cartoon feature on the processed image over the erased feature. Another customization process comprises the steps: (a) selecting from an array of preexisting graphic accessories an accessory to be added to the emoticon, and (b) scaling and manually superimposing the accessory onto the processed facial image.

The objects of this invention are further accomplished by a device for transforming a subject's facial image into a recognizable emoticon comprising a processor including data memory containing a digital image of the subject's face, the processor further comprising: (a) a process for removing any background of the image while preserving the facial image, (b) an algorithm for processing the facial image to make it cartoon-like but still recognizable as a representation of the face of the subject, and (c) a user interface for making the processed facial image available for use as an emoticon in a communication medium. Said device can further comprise: (a) memory in which the processor stores the processed facial image, (b) a customization process, and (c) a user interface by which the user can selectively apply the customization process to the stored processed facial image.

### BRIEF DESCRIPTION OF THE DRAWINGS

FIG. 1 illustrates steps and modules of a first embodiment of this invention.

FIG. 2 illustrates steps and modules of a second and third embodiment of this invention.

FIG. 3 illustrates steps and modules of a second embodiment of this invention.

FIG. 4 illustrates steps and modules of a third embodiment of this invention.

FIGS. 5-12 illustrate a progressive chain of intermediate images of a subject corresponding to intermediate steps performed by the steps and modules according to this invention.

FIG. 13 illustrates a user communication interface in which emoticons created according to this invention have been incorporated.

FIG. 14 illustrates an exemplary set of emoticons created according to this invention.

FIGS. 15 and 16 illustrate the automatic mode of background and facial feature erasures.

### DETAILED DESCRIPTION OF THE INVENTION

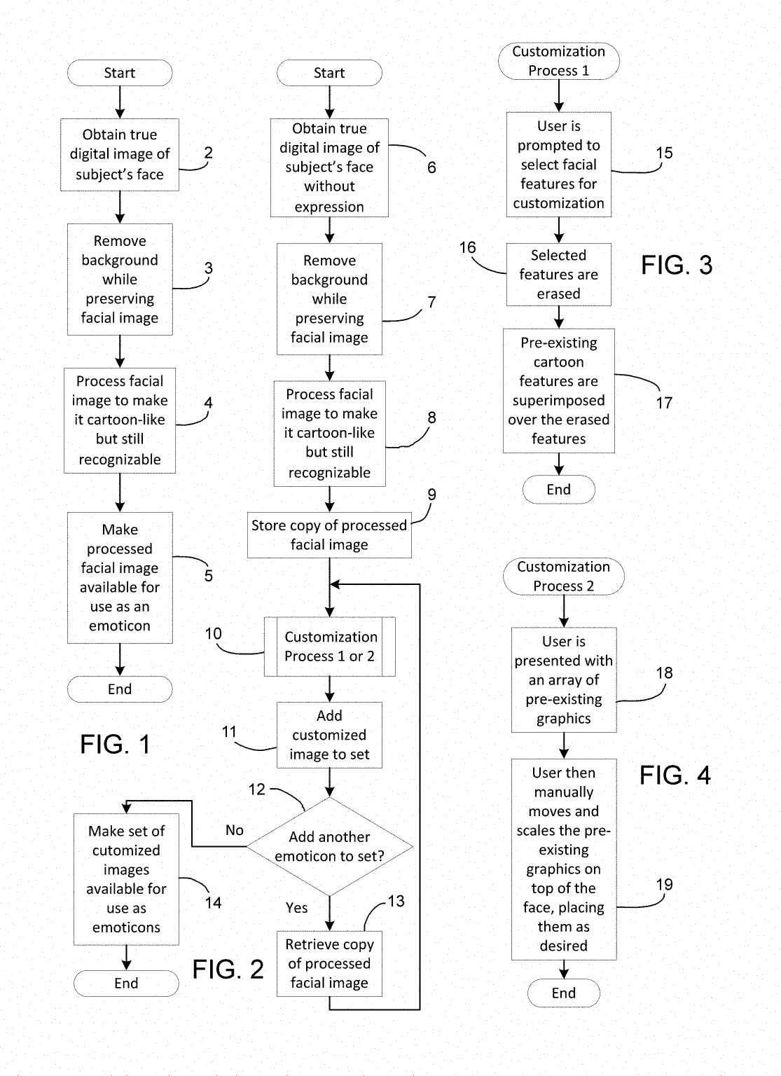

Referring to FIG. 1, a first embodiment for creating a set of recognizable custom emoticons representing a subject's face is as follows. First, a true digital image of the subject's face is obtained (2), for example, by using a digital camera or scanning a photograph. The digital image is put into data memory of a processor with a touch screen, and the methods described herein are performed either automatically by the processor or interactively between a user and the processor. The background of the digital image is then automatically or manually removed preserving just the face (3). The image is then processed (4), preferably by a Bilateral filter, in order to make the face appear more cartoon-like but still recognizable as a fair representation of the subject, especially to others familiar with the subject. This processed image is then made available for use (5) the same as conventional emoticons in all available electronic communication mediums (as explained below).

Other processing techniques can be used to produce a cartoon-like facial image from a true digital facial image of a subject while preserving the recognizability of the processed, that is, cartoon-like image as a fair representation of the subject. In addition to the Bilateral filter, examples of other processing techniques that can be used are: Anisotropic Diffusion, the Weighted Least Squares framework, the Edge-Avoiding Wavelets, Geodesic editing, Guided filtering, and the Domain Transform framework. In the context of this invention they are all, in general, edge preserving techniques that smooth away textures while retaining sharp edges to produce a recognizable cartoon-like image.

Referring to FIG. 2, in another embodiment, a true digital image of the subject's face without expression is obtained and put into processor memory. (6) The image background is then automatically or manually removed preserving just the face. (7) The image is then processed (8), for example by a Bilateral filter, in order to make the face appear more cartoon-like but still recognizable as a fair representation of the subject, especially to others familiar with the subject. A copy of the processed image, that is, the cartoonized image, is then stored (9) in processor memory for use in making multiple emoticons. If the user so desires, the processed image may be customized, by adding graphics (10) pre-existing, that is, pre-stored in processor memory, using preferably one of two customization processes. After customization the customized image is added to the set of emoticons being created (11). The user then decides whether he or she wants to add another customized image to the set (12), if so a copy of the previously stored processed image is retrieved (13). The retrieved copy is then customized (10) using preferably one of two customization processes. After the set of customized images is complete they are then made available for use (14) the same as conventional emoticons in all available electronic communication mediums (as explained below).

Referring to FIG. 3, a first customization process is illustrated. After the image is processed to be cartoon-like, the user is prompted to select one or more facial features in the processed image, for example, mouth, nose, eyes, eyebrows, chin, forehead (15) in order to identify them to the application. Selection of a facial feature can be made, for example, by touching the displayed facial feature. For each selected facial feature the application then erases the selected facial feature (16), preferably by painting over it with skin-colored pixels, and then the application automatically superimposes a pre-existing cartoon graphic over the erased feature. (17) In this way cartoon graphics, for example, a smile, a frown, a hat, glasses, and facial hair, can be superimposed on the processed image.

Referring to FIG. 4, another customization subprocess is illustrated in which the user is presented with an array of pre-existing cartoon graphics (18). The user then manually moves and scales the pre-existing graphics on top of the face, placing them as desired (19).

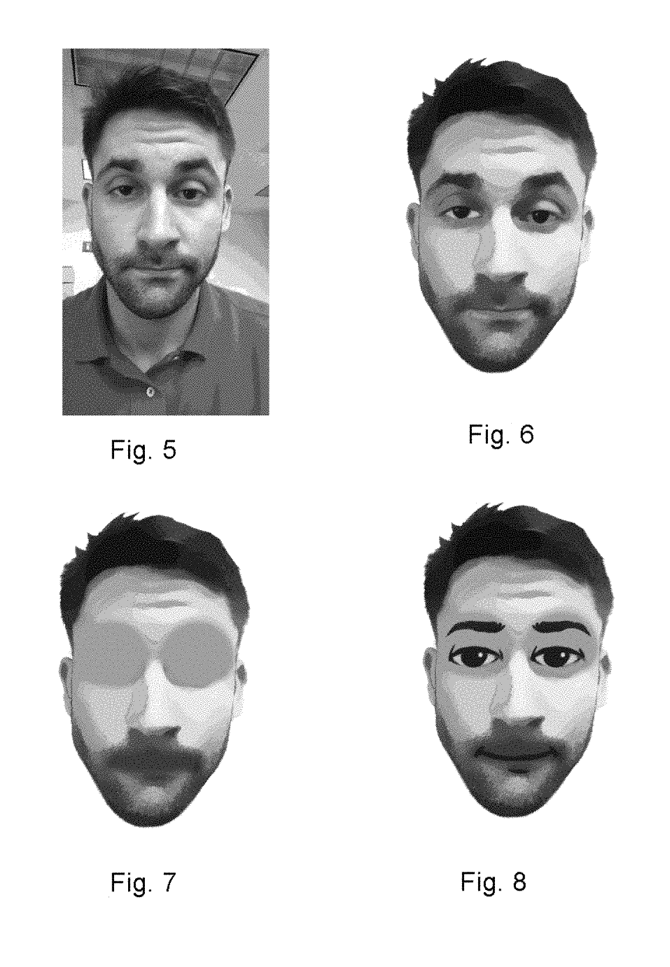

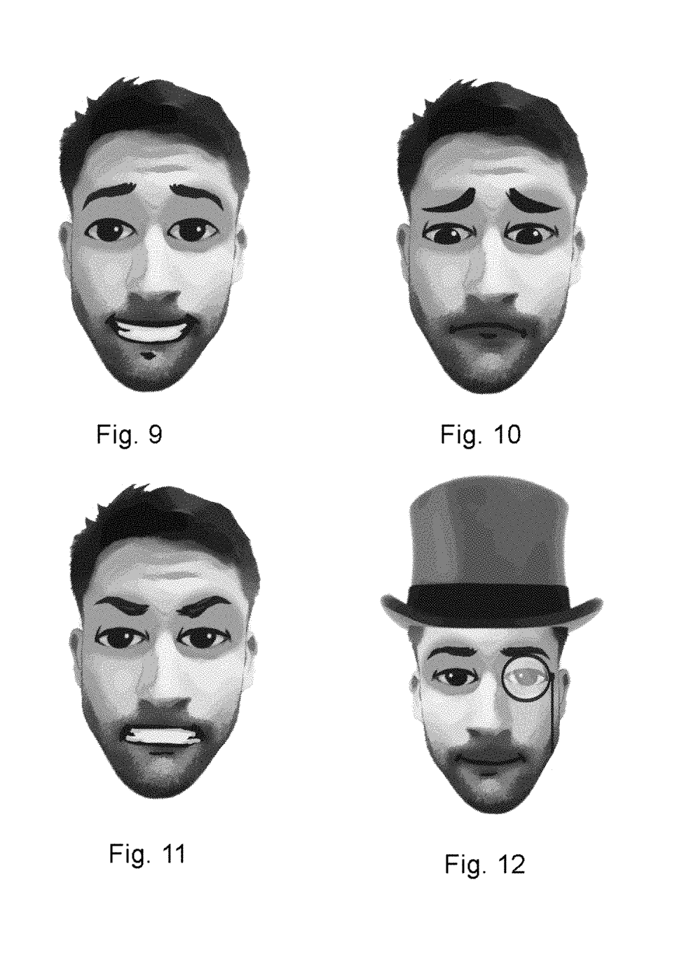

Referring to FIG. 5, a true image of a subject is illustrated, and FIG. 6 illustrates the image after being processed to be cartoon-like. FIG. 7 illustrates an intermediate stage in the customization of the cartoonized image of FIG. 6—the user has selected one or more facial features and those features have been erased as described above. FIGS. 8-12 illustrate examples of cartoon graphics having been superimposed over the erased facial features and accessories added—FIG. 8 a blank expression, FIG. 9 a happy expression, FIG. 10 a concerned expression, FIG. 11 an angry expression, and FIG. 12 in which top hat and monocle accessories have been added.

The superimposition of pre-drawn graphics allows a number of customizations of the face. Unlike conventional morphing this process does not change the pixels of the original image; instead pre-drawn artwork is placed over the existing image. This process gives the face a cute cartoonlike look that causes it to look similar to a typical emoticon. In addition, facial features like frowns and slanted eyebrows can convey moods. From a single photograph, any number of moods, hairstyles, and other representations can be made.

The resulting custom emoticons can be saved to a device as images. In one embodiment, the emoticons are added to the mobile device's default on-screen keyboard. In another embodiment, the emoticons are added to a plug-in keyboard that can be chosen as the default on-screen keyboard. The emoticons can then be sent to other devices using communication applications (SMS, Email, Facebook, etc) by tapping the emoticons on the keyboard. In one embodiment, in SMS applications, the emoticon is sent as a Unicode character and re-created as an image on the other device. In another embodiment, in SMS applications, the emoticon is sent as an MMS message. In another embodiment, in Apple iMessage, the emoticon is sent as an iMessage. In other applications (e.g. email), the emoticon is sent as a standard image (GIF, JPEG, etc). In another embodiment the application installs its own custom messaging application on the device that allows emoticons and text to be communicated to other devices.

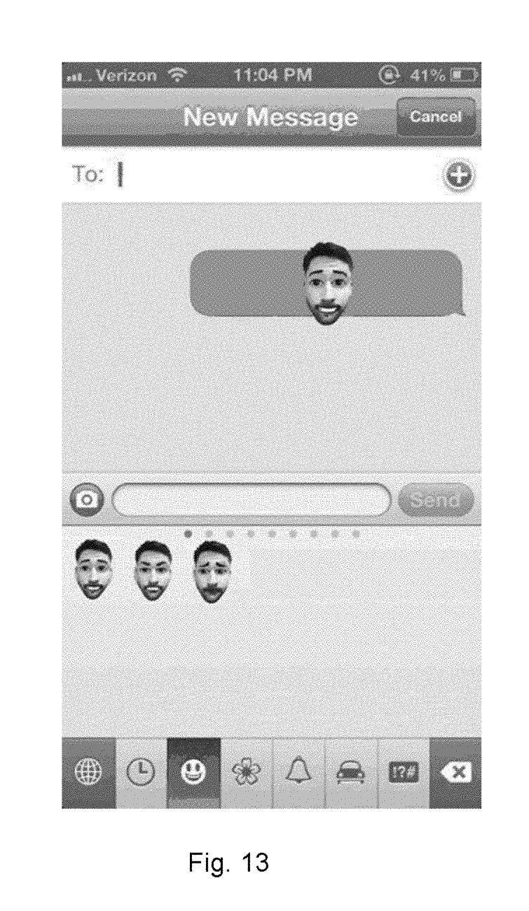

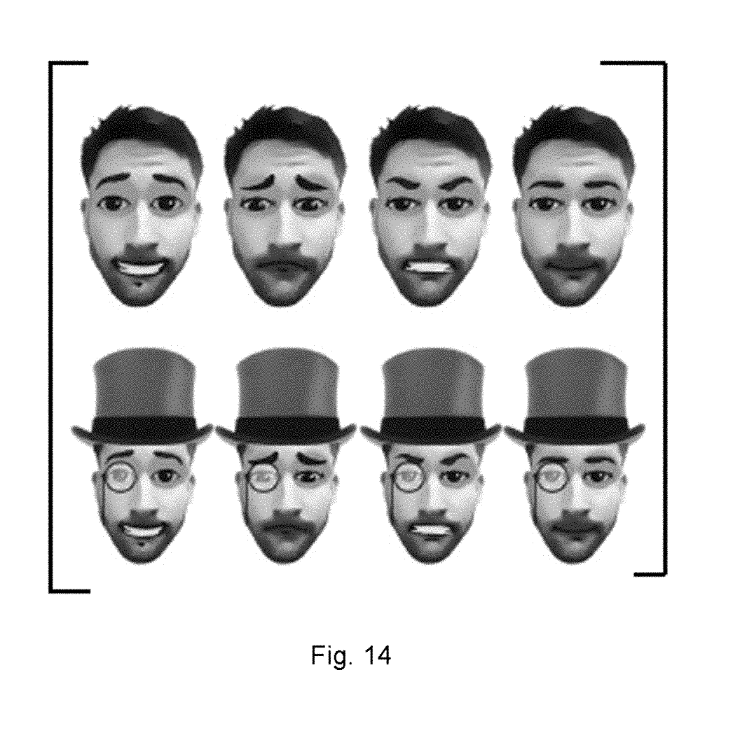

FIG. 13 illustrates emoticons created according to this invention added to a Standard iPhone SMS application—a user sends the custom emoticons to another device by tapping images at bottom.

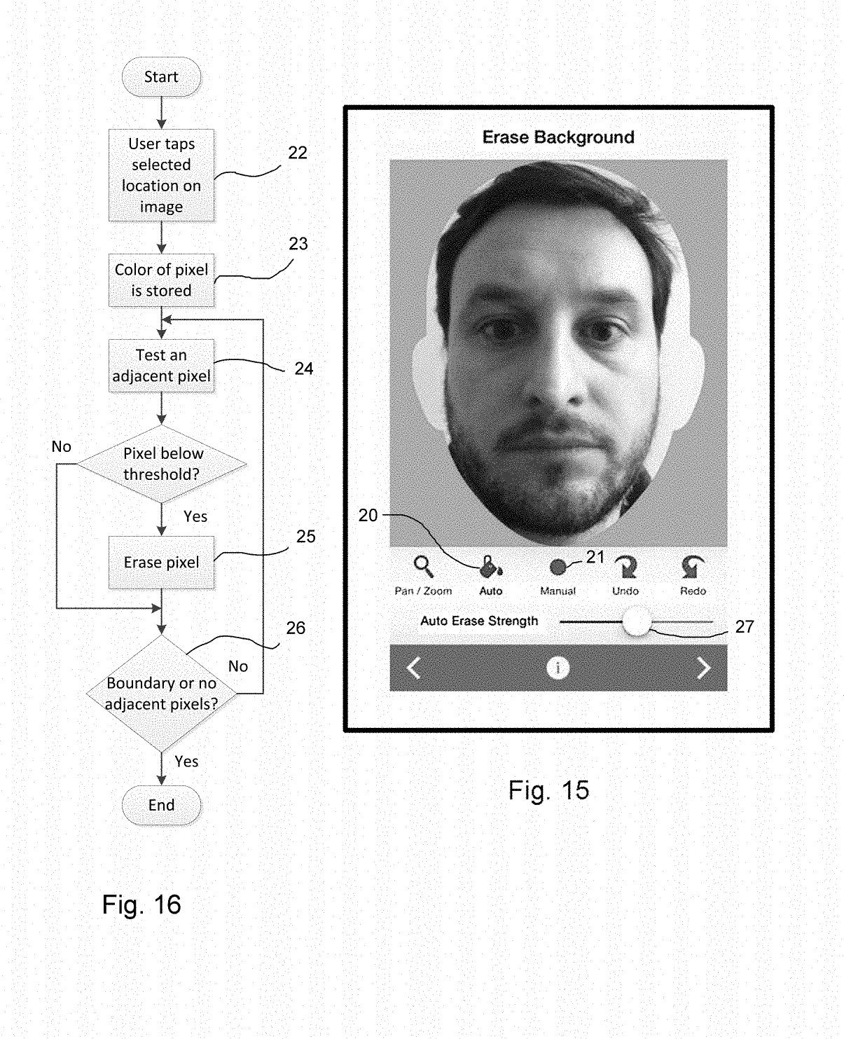

FIG. 14 illustrates further examples of custom emoticons created according to this invention. Referring to FIG. 15, the steps of removing the background (steps 3 and 7 of FIGS. 1 and 2 respectively) can be done automatically or manually. By default, automatic removal is selected: see the highlighted paint-bucket icon labeled “Auto” (20) at the bottom of FIG. 15. Tapping with a finger anywhere in the background will erase similar colors in that area, so that the face is kept but the background is removed. If any artifacts are left behind in the background, manual setting can be selected: see the dark circle labeled “Manual” (21) at the bottom of FIG. 15. If manual is selected, tapping and dragging on the image with a finger erases a circle around the location of your finger.

Referring to FIG. 16, specifically, when “Auto” is selected and the image is tapped (22) by the user, the pixel at the location tapped is selected, and the color value of the pixel is stored (23), for example, as a 32-bit RGBA value. Adjacent pixels are then tested (24) and if their colors are close enough, that is, within a threshold value of the original pixel, they are erased (25). For each pixel that is erased, all adjacent pixels are tested against the threshold, and if any adjacent pixel falls with the threshold value they too are erased. The algorithm stops searching once it hits a boundary, such as a terminal edge of the image, or if there are no adjacent pixels within the threshold value (26). The threshold value is set by using the slider at the bottom of FIG. 15 labeled “Auto Erase Strength” (27).

An emoticon created according to this invention can also be used as an avatar or primary facial picture on social networks like Facebook and Twitter, as well as games and other applications that allow uploading of a picture that represents the user. The application according to this invention can allow the user to connect with social media platforms and upload the custom emoticon to serve as the user's profile picture, or to share with others, for example, by posting or tweeting the emoticon.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

1. A method of transforming a subject's facial image into a recognizable emoticon comprising the steps:
a) obtaining a digital image of the subject's face and putting it into data memory of a processor,
b) removing any background of the digital image while preserving the facial image,
c) processing the facial image to make it cartoon-like but still recognizable as a representation of the face of the subject, and
d) making the processed facial image available for use as an emoticon in a communication medium.

2. The method according to claim 1 wherein the step of removing any background comprises the steps:
a) displaying the digital image on a touch screen,
b) tapping or, tapping and dragging a user's finger on or across the background displayed on the touch screen, and
c) erasing an area around all locations the finger makes contact with the screen.

3. The method according to claim 1 wherein the step of removing any background comprises the steps:
a) displaying the digital image on a touch screen,
b) tapping the background displayed on the touch screen with a user's finger,
c) selecting the pixel at the location tapped,
d) storing the color value of the selected pixel,
e) testing adjacent pixels and if their colors are within a threshold value of the stored pixel, erasing them,
f) for each pixel that is erased, testing all adjacent pixels against the threshold,
g) erasing all adjacent pixels that fall within the threshold value, and
h) repeating steps e) and f) above until a boundary is encountered or there are no adjacent pixels within the threshold value.

4. The method according to claim 1 further comprising the steps:
a) selecting a facial feature of the processed image for customization,
b) erasing the selected feature,
c) superimposing a pre-existing cartoon feature on the processed image over the erased feature.

5. The method according to claim 2 further comprising the steps:
a) selecting a facial feature of the processed image for customization,
b) erasing the selected feature,
c) superimposing a pre-existing cartoon feature on the processed image over the erased feature.

6. The method according to claim 3 further comprising the steps:
a) selecting a facial feature of the processed image for customization,
b) erasing the selected feature,
c) superimposing a pre-existing cartoon feature on the processed image over the erased feature.

7. The method according to claim 1 further comprising the steps:
a) selecting from an array of preexisting graphic accessories an accessory to be added to the emoticon, and
b) scaling and manually superimposing the accessory onto the processed facial image.

8. The method according to claim 2 further comprising the steps:
a) selecting from an array of preexisting graphic accessories an accessory to be added to the emoticon, and
b) scaling and manually superimposing the accessory onto the processed facial image.

9. The method according to claim 3 further comprising the steps:
a) selecting from an array of preexisting graphic accessories an accessory to be added to the emoticon, and
b) scaling and manually superimposing the accessory onto the processed facial image.

10. A method of transforming a subject's facial image into a set of recognizable emoticons comprising the steps:
a) obtaining a digital image of the subject's face without expression and putting it into data memory of a processor,
b) removing any background of the digital image while preserving the facial image,
c) processing the facial image to make it cartoon-like but still recognizable as a representation of the face of the subject,
d) storing a copy of the processed facial image,
e) retrieving the stored copy and applying a customization process to it to create an emoticon,
f) adding the created emoticon to a set of emoticons,
g) if more emoticons are to be added to the set, repeating steps e) through f),
h) when the set of emoticons is complete making the set available for use in a communication medium.

11. The method according to claim 10 wherein the step of removing any background comprises the steps:
a) displaying the digital image on a touch screen,
b) tapping or, tapping and dragging a user's finger on or across the background displayed on the touch screen, and
c) erasing an area around all locations the finger makes contact with the screen.

12. The method according to claim 10 wherein the step of removing any background comprises the steps:
a) displaying the digital image on a touch screen,
b) tapping the background displayed on the touch screen with a user's finger,
c) selecting the pixel at the location tapped,
d) storing the color value of the selected pixel,
e) testing adjacent pixels and if their colors are within a threshold value of the stored pixel, erasing them,
f) for each pixel that is erased, testing all adjacent pixels against the threshold, and
g) if any adjacent pixel falls with the threshold value erasing them, and
h) repeating steps e) and f) above until a boundary is encountered or there are no adjacent pixels within the threshold value.

13. The method according to claim 10 wherein the step of applying a customization process comprises the steps:
a) selecting a facial feature from the stored facial image for customization,
b) erasing the selected feature,
c) superimposing a pre-existing cartoon feature over the erased feature.

14. The method according to claim 11 wherein the step of applying a customization process comprises the steps:
a) selecting a facial feature from the stored facial image for customization,
b) erasing the selected feature,
c) superimposing a pre-existing cartoon feature over the erased feature.

15. The method according to claim 12 wherein the step of applying a customization process comprises the steps:
a) selecting a facial feature from the stored facial image for customization,
b) erasing the selected feature,
c) superimposing a pre-existing cartoon feature over the erased feature.

16. The method according to claim 10 wherein the step of applying a customization process comprises the steps:
a) selecting from an array of preexisting graphic accessories an accessory to be added to the stored facial image, and
b) scaling and manually superimposing the accessory onto the stored facial image.

17. The method according to claim 11 wherein the step of applying a customization process comprises the steps:
a) selecting from an array of preexisting graphic accessories an accessory to be added to the stored facial image, and
b) scaling and manually superimposing the accessory onto the stored facial image.

18. The method according to claim 12 wherein the step of applying a customization process comprises the steps:
a) selecting from an array of preexisting graphic accessories an accessory to be added to the stored facial image, and
b) scaling and manually superimposing the accessory onto the stored facial image.

19. A device for transforming a subject's facial image into a recognizable emoticon comprising a processor including data memory containing a digital image of the subject's face, the processor further comprising:
a) a process for removing any background of the image while preserving the facial image,
b) an algorithm for processing the facial image to make it cartoon-like but still recognizable as a representation of the face of the subject, and
c) a process for making the processed facial image available for use as an emoticon in a communication medium.

20. The device according to claim 19 further comprises:
a) memory in which the processor stores the processed facial image,
b) a customization process, and
c) a user interface by which the user can selectively apply the customization process to the stored processed facial image.
